(19) United States
(12) Patent Application Publication
(10) Pub. No.: US 2023/0055477 A1
(43) Pub. Date: Feb. 23, 2023

(54) SPEECH-ENABLED AUGMENTED REALITY

(71) Applicant: SoundHound, Inc., Santa Clara, CA (US)

(72) Inventors: Keyvan MOHAJER, Los Gatos, CA (US); Morris MICHAEL, Gilroy, CA (US); Bernard MONT-REYNAUD, Morgan Hill, CA (US)

(73) Assignee: SoundHound, Inc., Santa Clara, CA (US)

(21) Appl. No.: 17/445,653

(22) Filed: Aug. 23, 2021

(51) Int. Cl. G06K 9/00; G06T 7/70; G10L 15/08; G10L 15/22; G06T 11/60; G06F 3/01; G06K 9/62

(52) U.S. Cl. CPC G06K 9/00671; G06T 7/70; G10L 15/08; G10L 15/22; G06T 11/60; G06F 3/011; G06K 9/6267; G06T 2207/20092; G06K 9/00201; G10L 2015/088; G10L 2015/223

(57) ABSTRACT

Methods and systems for implementing an intuitive interaction between the user and the virtual content of augmented reality applications are disclosed. By implementing an augmented reality inquiry mode of a device, the system can enable a user to interact with relevant virtual objects via a speech-enabled interface. The speech-enabled augmented reality system can identify visual objects in images and recognize virtual objects corresponding to the visual objects, determine one or more relevant objects from the virtual objects based on relevance factors. Once the interaction session is established, a user can further interact with the relevant virtual objects, notably through voice commands addressed to the object. Accordingly, the present subject matter can enable a natural and hands-free interaction between the user and any virtual object that the user is interested in.

### TECHNICAL FIELD

The present subject matter is in the field of artificial intelligence type computers and digital data processing systems and corresponding data processing methods and products for emulation of intelligence. More particularly, embodiments of the present subjectmatter relate to methods and systems for machine vision, including content based image retrieval, augmented reality, and tracking of optical flow and speech signal processing, including natural language and speech interfaces.

### BACKGROUND

In recent years, augmented reality (AR) or mixed reality has been increasingly popular with the ever-growing computing power and the demand for new human-machine interfaces. Augmented reality can deliver a real-time view of a physical environment that has been virtually enhanced or modified by computer-generated content. Augmented reality can provide virtual information to the user, for example, to guide through a surgery. It can also provide entertaining content via AR gaming.

Traditional input devices for an AR system include a wireless wristband for a head mount AR headset, a touch screen for a handheld display, or the mobile device itself as a pointing device.

### SUMMARY OF THE INVENTION

The present subject matter pertains to improved approaches to create an intuitive interaction between the user and the virtual content of AR applications. The AR system can provide natural, speech-enabled interactions with virtual objects, which can associate virtual information with objects in a user's immediate surroundings.

Specifically, the present subject matter implements an AR inquiry mode of a device that can superimpose virtual cues to identified relevant objects in a live view of physical, real-world objects. By utilizing a speech recognition system, the AR system can enable a natural and hands-free interaction between the user and any virtual object that the user is interested in. A relevancy model can determine relevant objects from a plurality of virtual objects, based on, for example, user's input data, gesture data, location/position data of the virtual object, or a predetermined relevancy.

Furthermore, various sensors can be used to track the device's location data, relative position data, and/or the user's gesture data including the viewpoint. Such data can be used to determine, for example, the user's implied or explicit instruction to activate an AR inquiry mode, the user's real-time viewpoint, and the relevancy of a virtual object. In addition, the relative position data and the user's viewpoint data can be used to generate a dynamic rendering of the virtual content.

A computer-implementation of the present subject matter comprises: receiving an image by camera(s) of a device, recognizing one or more virtual objects in the image, determining a relevant object from the one or more virtual objects in the image, overlaying, in the image, text indicating a corresponding key phrase associated with the relevant object on a display of the device, receiving speech audio from a user, inferring a key phrase associated with the relevant object based on the speech audio; and enabling an interaction session with the user, wherein the user can obtain information related to the relevant object via a voice interface of the device.

According to some embodiments, the method of the present subject matter further comprises, prior to receiving an image, receiving an explicit user input to activate the AR inquiry mode, and initializing the AR inquiry mode by capturing the visual surroundings of the device with a camera of the device. According to some embodiments, the method further comprises receiving an explicit user input to terminate the AR inquiry mode.

According to some embodiments, the method of the present subject matter further comprises, prior to receiving an image, inferring, based on user input data, an implied user intention to activate the AR inquiry mode, and initializing the AR inquiry mode by capturing the visual surroundings of the device. According to some embodiments, the method further comprises receiving an implied user intention to terminate the AR inquiry mode.

According to some embodiments, the method further comprises determining location data of the virtual objects in the image. According to some embodiments, the method further comprises determining a respective type of the one or more virtual objects in the image and requesting data entries for the one or more virtual objects based on the respective type.

According to some embodiments, the method further comprises requesting data entries for the virtual objects and receiving a plurality of available data entries related to the relevant object. Furthermore, the method further comprises determining, based on the plurality of available data entries, one or more suggested queries, and rendering, in the image, text indicating the one or more suggested queries on the display.

According to some embodiments, the method step of determining the relevant object from the one or more virtual objects in the image further comprises determining, based on a relevance factor, a respective probability that the user will interact with the virtual objects, and selecting the relevant object based on the respective probability exceeding a predetermined threshold. Furthermore, the relevance factor can comprise one or more of the user's input, user's gesture data, location and/or position data of the relevant object and a predetermined relevancy designation.

According to some embodiments, the method further comprises receiving, from an information provider, customized information related to the relevant object, and providing the customized information to the user in the interaction session.

According to some embodiments, the method further comprises receiving additional speech audio from a user, inferring, by the speech recognition system, a query associated with the relevant object based on the additional speech audio, determining, by the device, a response to the query, and providing a response to the query via the voice interface of the device. Furthermore, the method step of enabling an interaction session with the user further comprises determining, by the speech recognition system, the query is ambiguous, generating one or more disambiguating questions, and providing the one or more disambiguating questions to the user.

Another computer-implemented of the present subject matter comprises receiving, by a camera of a device, an image, showing the image on a display of the device, recognizing one or more virtual objects in the image, determining a relevant object from the one or more virtual objects in the image; and overlaying, in the image, text indicating a corresponding key phrase associated with the relevant object on the display.

According to some embodiments, the method of the present subject matter further comprises determining location data of the virtual objects in the image. According to some embodiments, the method further comprises determining a respective type of the one or more virtual objects in the image and requesting data entries for the one or more virtual objects based on the respective type.

According to some embodiments, the method further comprises requesting data entries for the virtual objects and receiving available data entries related to the relevant object.

According to some embodiments, the method step of determining the relevant object from the one or more virtual objects in the image further comprises: determining, based on a relevance factor, a respective probability for a user to interact with the one or more virtual objects, and selecting the relevant object based on the respective probability exceeding a predetermined threshold.

A computer system of the present subject matter comprises at least one processor, a display, at least one camera, and memory including instructions that, when executed by the at least one processor, cause the computer system to: receive, by the camera, an image, recognize one or more virtual objects in the image, determine at least one relevant object from the virtual objects in the image, overlay, in the image, text indicating a corresponding key phrase associated with the at least one relevant object on the display, receive speech audio from a user, infer a key phrase associated with a relevant object based on the speech audio, and enable an interaction session with the user, wherein the user can obtain information related to the relevant object.

According to some embodiments, the computer system further determines the location data of the virtual objects in the image. According to some embodiments, the computer system further requests data entries for the virtual objects and receive a plurality of available data entries related to the at least one relevant object.

According to some embodiments, the computer system further determines, based on a relevance factor, a respective probability for a user to interact with the one or more virtual objects and selects the at least one relevant object based on the respective probability exceeding a predetermined threshold.

According to some embodiments, the computer system further receives, from an information provider, customized information related to the at least one relevant object, and provide the customized information to the user in the interaction session.

Other aspects and advantages of the present subject matter will become apparent from the following detailed description taken in conjunction with the accompanying drawings, which illustrate, by way of example, the principles of the present subject matter.

### DESCRIPTION OF DRAWINGS

The present subject matter is illustrated by way of example, and not by way of limitation, in the figures of the accompanying drawings and in which:

FIG. 1 shows a system that is configured to implement an AR inquiry mode of a device, according to one or more embodiments of the present subject matter;

FIG. 2 shows a system that is configured to implement an AR inquiry mode of a device in conjunction with a speech recognition system, according to one or more embodiments of the present subject matter;

FIG. 3 shows an example in which a computing device configured to implement an AR inquiry mode, according to one or more embodiments of the present subject matter;

FIG. 4 shows a scanning process of the computing device configured to implement the AR inquiry mode, according to one or more embodiments of the present subject matter;

FIG. 5 shows an identifying process for relevant objects, according to one or more embodiments ofthe present subject matter;

FIG. 6 shows a process in which relevant objects are identified and tagged, according to one or more embodiments of the present subject matter;

FIG. 7 shows examples of key phrases that can be associated with relevant objects, according to one or more embodiments of the present subject matter;

FIG. 8 shows exemplary questions for a selected object, according to one or more embodiments of the present subject matter;

FIG. 9 shows an example in which an automobile is configured to implement an AR inquiry mode via a head-up display (HUD), according to one or more embodiments of the present subject matter;

FIG. 10 shows an example in which an automobile is configured to implement an AR inquiry mode via a dashboard display, according to one or more embodiments of the present subject matter;

FIG. 11A and 11B show an example in which smart glasses are configured to implement an AR inquiry mode, according to one or more embodiments of the present subject matter;

FIG. 12A and 12B shows an example in which a head-mount AR device is configured to implement an AR inquiry mode, according to one or more embodiments of the present subject matter;

FIG. 13 is an exemplary flow diagram illustrating aspect of a method having features consistent with some implementations of the present subject matter;

FIG. 14 is another exemplary flow diagram illustrating aspect of a method having features consistent with some implementations of the present subject matter;

FIG. 15A shows a cloud server according to one or more embodiments of thepresent subject matter;

FIG. 15B shows a diagram of a cloud server according to one or more embodimentsof the present subject matter;

FIG. 16 shows a mobile device that can be configured to implement an AR inquiry mode, according to one or more embodiments of the present subject matter;

FIG. 17A shows a packaged system-on-chip according to one or moreembodiments of the present subject matter;

FIG. 17B shows a diagram of a system-on-chip according to one or moreembodiments of the present subject matter; and

FIG. 18 shows a non-transitory computer-readable medium according to one ormore embodiments of the present subject matter.

### DETAILED DESCRIPTION

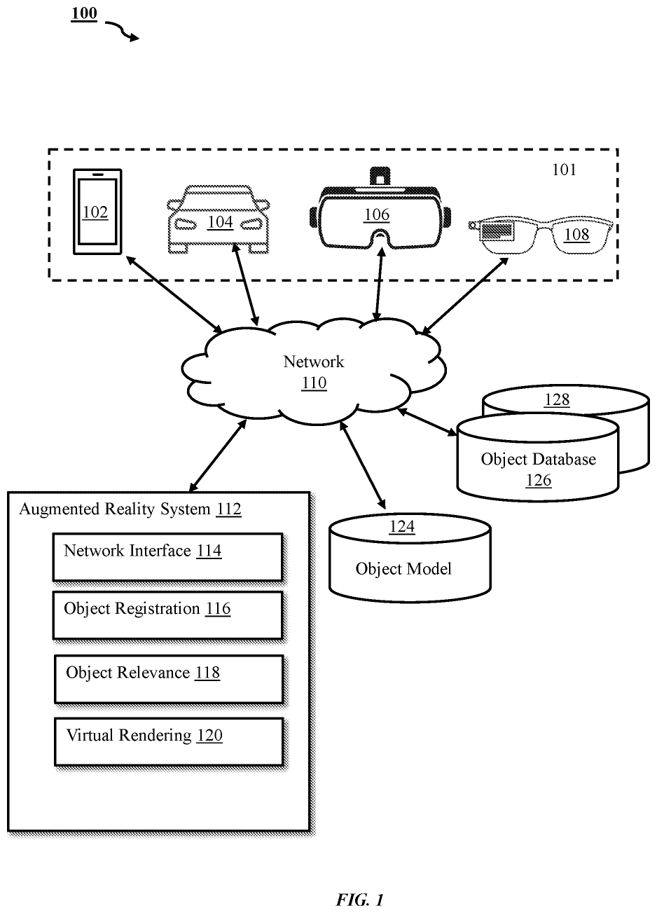

The present subject matter pertains to improved approaches to create a virtual object interaction with the user. It enables an AR inquiry mode of a device in which a user can interact with relevant virtual objects via a speech-enabled interface. By adopting a speech recognition system, the AR system can enable a hands-free interaction between the user and any virtual object that the user is interested in. Embodiments of the present subject matter are discussed below with reference to FIGS. 1-18.

In the following description, for purposes of explanation, numerous specific details are set forth in order to provide a thorough understanding of the present subject matter.It will be apparent, however, to one skilled in the art that the present subject matter may be practiced without some of these specific details. In addition, the following description provides examples, and the accompanying drawings show various examples for the purposes of illustration. Moreover, these examples should not be construed in a limiting sense as theyare merely intended to provide examples of embodiments of the subject matter rather than toprovide an exhaustive list of all possible implementations. In other instances, well-known structures and devices are shown in block diagram form in order to avoid obscuring the details of the disclosed features of various described embodiments.

FIG. 1 shows a system 100 that is configured to implement user interactions with virtual objects shown by a client device 101. A client device can be any computing device capable of rendering augmented reality by showing 2D virtual model data together with 3D real-world image data. As shown in FIG. 1, examples of a client device 101 can be a mobile phone 102, a smart car 104, an AR headset or a head mount display (HMD) 106, smart glasses 108, or a tablet computer, or any combination thereof.

A client device 101 can have a display system comprising a processor and a display. The processor can be, for example, a microprocessor, or a digital signal processor. It can receive and configure virtual model data to be shown along with the real-world image data. According to some embodiments, the display can be a see-through display made of transparent materials such as glass. A see-through display enables a user to directly see his/her surroundings through the display. Furthermore, the see-through display can be an optical see-through display or a video see-through display, or a combination of both.

An optical see-through display can comprise optical elements that can direct light from light sources towards the user's eye such that he/she can see the virtual objects as being superimposed on real-world objects. For example, a heads-up display or HUD in smart car 104 can have an optic see-through display projected on the windshield. Similarly, AR headset 106 or smart glass 108 can have an optical see-through display. By contrast, a video see-through display can show virtual content data along with the real-world image data in a live video of the physical world. In other words, the user can “see” a video of the real-world objects on a video see-through display. For example, the display on mobile phone 102 can be a video see-through display, and the dashboard display in smart car 104 can be a video see-through display.

Client device 101 can further comprise at least one processor, one camera as I/O devices, at least one microphone for receiving voice commands, at least one speaker, and at least one network interface configured to connect to network 110.

Network 110 can comprise a single network or a combination of multiple networks, such as the Internet or intranets, wireless cellular networks, local area network (LAN), wide area network (WAN), WiFi, Bluetooth, near-field communication (NFC), etc. Network 110 can comprise a mixture of private and public networks, or one or more local area networks (LANs) and wide-area networks (WANs) that may be implemented by various technologies and standards.

As shown in FIG. 1, in communication with relevant databases via network 110, augmented reality system 112 can execute numerous functions related to rendering AR on client device 101. According to some embodiments, in communication with client device 101 via network interface 114, augmented reality system 112 can be implemented by processors in a host server via a cloud-based processing structure. Alternatively, at least partial functions of augmented reality system 112, such as object registration 116 or virtual rendering 120, can be implemented by client device 101 or a local computing device.

According to some embodiments, client device 101, during a scanning process, can receive real-world image data via one or more cameras. Such data can be processed in real-time for object registration 116. According to some embodiments, an object registration module is configured to recognize and identify one or more virtual objects in the image data. In this process, the system can recognize and associate 3D physical objects in the real world to virtual objects. For example, object registration 116 can use feature detection, edge detection, or other image processing methods to interpret the camera images. Interpreting the images can be done with programmed expert systems or with statistical models trained on data sets. A typical statistical model for object detection is a convolutional neural network that observes features in images to infer probabilities or locations of the presence of classes of objects. Various object detection, object recognition and image segmentation in computer visions can be utilized.

According to some embodiments, augmented reality system 112 can retrieve and/or calculate location data of the identified virtual objects. Such location data can be obtained via multi-mode tracking through various sensors for satellite geolocation such as Global Positioning System (GPS), WiFi location tracking, radio-frequency identification (RFID), Long Term Evolution for Machines (LTE-M), or a combination thereof. For example, client device 101 can retrieve its GPS coordinates as an approximate address of an identified virtual object, e.g., a building located at 742 Evergreen Terrace, Springfield. Accordingly, augmented reality system 112 can retrieve relevant information related to the identified building, e.g., 742 Evergreen Terrace, Springfield, from object database 126.

According to some embodiments, multiple object databases, e.g., 126 and 128, can be used to store different types of object information. An example of object database 126 can be a Geographic Information System (GIS), which can provide and correlate geospatial data, e.g., GPS coordinates with details of the identified object such as services, building history, etc. Another example of object database 126 can be a database provided by a third party, such as a customized domain database. Yet another example of object database 126 can be a third-party website or web API that contains information related to a specific type of the identified virtual object.

According to some embodiments, the object registration module is further configured to determine a type or class of the virtual object, e.g., a building, a book, a gas station. For example, the object registration module can retrieve attributes associated with the virtual object. For example, the object registration module can also extract natural features of the virtual object to determine its type. Based on a determined type of the virtual object, augmented reality system 112 can retrieve relevant data from one or more corresponding object databases. For example, the system can retrieve relevant information related to a building from a GIS database, retrieve information related to a book from the Internet or a review website, or seek information related to a gas station from a customized domain database.

As shown in FIG. 1, according to some embodiments, following the identification of virtual objects, an object relevance module can determine or suggest a relevant object from the identified virtual objects. For example, a relevance score can be assigned to each identified virtual object. The determination of object relevance 118 can be beneficial because when a plurality of virtual objects are identified, some objects are likely more relevant than other objects for the user. By avoiding marking potentially irrelevant virtual objects for the AR modification or AR marking, the system can not only improve its processing efficiency but also streamline its AR-enhanced interface for optimized user experience.

According to some embodiments, object relevance 118 can be determined by the availability of data associated with an object. For example, after identifying three different virtual objects, the system can send requests to retrieve data entries for all three virtual objects from object databases126 and 128. If the system only receives data for one object, it can mark the one object as a relevant object for AR marking. In another example, when the system receives data entries related to multiple virtual objects, it can mark any virtual object with available data as a relevant object.

According to some embodiments, object relevance 118 can be determined by a relevance factor indicating an estimated probability that the user will be interested in a virtual object or that the user will interact with the virtual object. According to some embodiments, a relevance factor can be location data, e.g., GPS or other location-tracking techniques, as described herein. For example, when location data indicates that smart car 104 (along with the user) is approaching a gas station as shown in a display, the system can identify the gas station and determine it as a relevant virtual object.

According to some embodiments, a relevance factor can be relative position data indicating a position of the virtual object relative to the client device's camera. For example, various sensors, such as cameras, radar modules, LiDAR sensors, proximity sensors, can determine the orientation angle and distance between the virtual object and the client device. Furthermore, sensors such as cameras, accelerometers, gyroscopes can determine the speed and direction of the client device. According to some embodiments, the system can conclude that a first virtual object that is closer to the device is likely to be a relevant object for the AR marking. Similarly, the system can determine an object has high relevance if the front side of the client device is facing toward it and the object is close to the device.

According to some embodiments, a relevance factor can be the user's gesture data, such as tracked viewpoint or head/body movement. For example, various sensors, e.g., cameras, accelerometers, gyroscopes, radar modules, LiDAR sensors, proximity sensors, can be used to track speed and direction of the user's body and hand gestures. Furthermore, various sensors can be used to track the user's eye movement to calculate the line of sight. For example, if a user's eye is fixed on a virtual object for a predetermined amount of time, the system can conclude the object has high relevanceto the user. Similarly, if the user walks towards a virtual object (gesture data), the system can determine the object has high relevance for further AR processing.

According to some embodiments, a relevance factor can be based on the user's direct or implied input. For example, the user can inquire directly about a TV when the system identifies several electronic devices in an image, thus making the TV a relevant object. Also, the user's past communication data, for example, talking about a weekend road trip while driving in smart car 104, can be used as implied input to infer that a gas station can be a relevant object in an image.

According to some embodiments, a relevance factor can be predetermined by a system administrator or a third-party administrator. For example, a third-party domain provider, e.g., a gas station owner or a gas station advertiser, can define a virtual object corresponding to the gas station as relevant for marketing and promotion purposes.

Furthermore, augmented reality system 112 can adopt a relevance model based on multiple relevance factors that can be assigned with different weights. The output of the relevance model can be a probability that the user will interact with the virtual object. According to some embodiments, the system can select several relevant objects with respective probability exceeding a predetermined threshold.

As shown in FIG. 1, according to some embodiments, following the determined relevant object, a virtual rendering module 120 can generate and overlay text indicating a corresponding key phrase, or an AR marker, next to the relevant object. The superimposed text can appear to be “anchored” to the virtual object in the image, meaning it can dynamically change its location or appearance according to the user's perspective. According to some embodiments, multiple corresponding key phrases can be generated for multiple relevant objects.

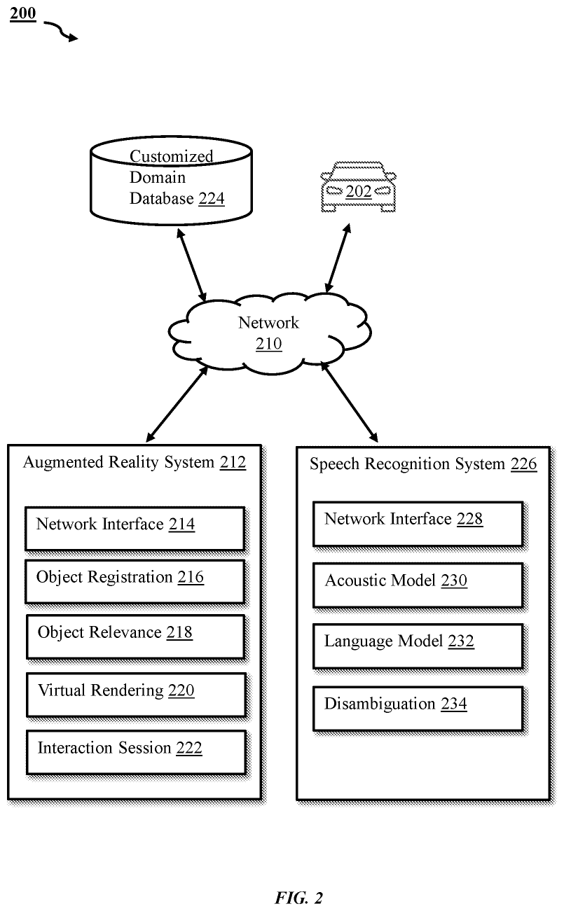

FIG. 2 shows a system that is configured to implement virtual object interactions with device 202 in conjunction with a speech recognition system 226. Device 202 can be any computing device capable of rendering augmented reality. As shown earlier, examples of a client device 202 can be a smart car, a mobile device, an AR headset, smart glasses, or a head mount display (HMD), a tablet computer, or any combination thereof.

Device 202 can have a display system comprising a processor and a display. The processor can receive and configure virtual model data to be shown along with the real-world image data. According to some embodiments, the display can be a see-through display made of transparent materials such as glass, which enables a user to directly see his/her surroundings through the display. Furthermore, the see-through display can be an optical see-through display or a video see-through display, or a combination of both. Device 202 can further comprise I/O devices including at least one camera for capturing images, at least one microphone for receiving voice commands, and at least one network interface configured to connect to network 210.

As shown in FIG. 2, in communication with relevant databases such as customized domain database 224 and speech recognition system 226, augmented reality system 212 can execute numerous functions, e.g., objection registration 216, object relevance 218, virtual rendering 220 and interaction session 222, to implement an AR inquiry mode through Device 202.

According to some embodiments, device 202 can receive explicit user input to activate an AR inquiry mode. For example, a user can use a voice command, e.g., an audio cue, “look around”, to initialize the AR inquiry mode by scanning the visual surroundings of the device. Accordingly, device 202 is configured to turn on its camera(s) and capture an image or a stream of images from the user's surroundings. For example, the user can use a gesture command, e.g., a swipe of a hand, to activate the AR inquiry mode. In another example, the user can activate the AR mode by manually clicking a button on device 202. In yet another example, the user can open an AR inquiry application and start to point and shoot at real-world objects that he/she wishes to find more about and interact with. According to some embodiments, device 202 can receive an implied user intention to activate an AR inquiry mode. By inferring a user's likelihood of interest in a real-world object, augmented reality system 212 can automatically activate the AR inquiry mode. For example, when the system detects the user is reaching proximity to the real-world object via tracked activity data or location data. In another example, while driving in a smart car, e.g., device 202, the user mentioned an upcoming weekend road trip. By analyzing the level of gas in the tank and concluding that the user needs to find a gas station (real-world object), the AR inquiry mode can be automatically activated once the car reaches a predetermined distance from a gas station.

According to some embodiments, device 202 can receive direct user input to terminate an AR inquiry mode. For example, a user can use a voice command, e.g., an audio cue such as “stop looking,” “stop scanning,” or “stop AR,” to end the AR inquiry mode. For example, the user can use a gesture command to conclude the AR inquiry mode. Accordingly, device 202 is configured to turn off its camera(s) and cease the AR processing.

According to some embodiments, device 202 can receive an implied user intention to deactivate an AR inquiry mode. For example, the user can initiate another application on device 202, which can automatically deactivate deactivate or overwrite the AR inquiry process. For example, a lack of user input or feedback for a predetermined amount of time can be used to terminate the AR inquiry process via a timeout mechanism. According to some embodiments, the predetermined amount of time can be configurable by the system administrator or the user.

According to some embodiments, various sensors can be used to collect the user's gesture data, such as head/body movement and eye movement. Such data can be processed to determine, for example, the user's implied instruction to activate an AR inquiry mode.

According to some embodiments, once the AR inquiry mode is activated, device 202 can receive real-world image data via one or more cameras, which can be processed in real-time for object registration 216 during a scanning process. An object registration module is configured to scan the user's surroundings, and identify one or more virtual objects in the image data. In this process, the system can track, recognize and associate 3-D physical objects in the real world to 2-D virtual objects. As discussed herein, various object detection, object recognition and image segmentation in computer visions can be utilized.

According to some embodiments, augmented reality system 212 can retrieve and/or calculate location data of the one or more identified virtual objects. Such location data can be obtained via multi-mode tracking various sensors for GPS, RFID, LTE-M, or a combination thereof. For example, device 202 can retrieve its real-time GPS coordinates and use it as the estimated location data of the virtual object.

According to some embodiments, augmented reality system 212 can determine a type or class of the virtual object, e.g., a building, a book, a gas station. For example, the object registration module can retrieve attributes associated with the virtual object. Based on a determined type of the object, augmented reality system 212 can retrieve relevant data from one or more corresponding object databases. For example, the system can retrieve information related to a gas station from a customized domain database 224, which can be preconfigured by a domain information provider for marketing and promoting information that can be provided to a user via AR.

As shown in FIG. 2, according to some embodiments, following the identification of virtual objects, an object relevance module, e.g., object relevance 218, can determine or suggest a relevant object from the identified virtual objects. For example, a relevance score can be assigned to each identified virtual object. This can generate AR marking for potentially relevant virtual objects, thus avoiding AR marking for unnecessary, irrelevant objects.

According to some embodiments, object relevance 218 can be determined by the availability of data associated with an object. For example, following identifying objects A, B and C in images, the system can send requests to retrieve data entries for all objects from various object databases. If they system only receives data for object A, it can mark object A as a relevant object and generate AR markings for it. In another example, when the system receives data entries related to all three objects, the system can mark all objects as relevant objects.

According to some embodiments, object relevance 218 can be determined by a relevance factor indicating an estimated probability that the user will be interested in a virtual object, or to interact with the virtual object. According to some embodiments, augmented reality system 212 can adopt a relevance model based on one or more relevance factors that can be assigned with different weights. The output of the relevance model can be a probability that the user will interact with the virtual object. According to some embodiments, the system can determine several relevant objects with respective probability exceeding a predetermined threshold.

According to some embodiments, such a relevance factor can be location data, e.g., GPS or other location-tracking techniques, as described herein. For example, when location data indicates that smart car 104 (along with the user) is approaching a gas station as shown in a display, the system can identify the gas station and determine it as a relevant virtual object.

According to some embodiments, a relevance factor can be position data indicating a position of the virtual object relative to device 202. For example, various sensors such as cameras, radar modules, LiDAR sensors, proximity sensors can determine the distance between the virtual object and device 202. Furthermore, sensors such as cameras, accelerometers, gyroscopes can determine the speed and direction of the client device. According to some embodiments, the system can conclude that a first virtual object is more likely to be a relevant object for the AR marking because it is closer to the device than a second virtual object. Similarly, the system can determine an object has high relevance if the front side of the client device is facing forward toward it and the object is close to the device.

According to some embodiments, a relevance factor can be the user's gesture data, such as his/her tracked viewpoint or body movement. For example, various sensors, e.g., cameras, accelerometers, gyroscopes, radar modules, LiDAR sensors, proximity sensors, can be used to track speed and direction of the user's gestures. Furthermore, these sensors can be used to track the user's eye movement via, for example, line of sight. For example, if a user's eye is fixed on a virtual object for a predetermined amount of time, the system can conclude the object has high relevance to the user. Similarly, if the user walks towards a virtual object (gesture data), the system can determine the object has high relevance for further AR processing.

According to some embodiments, a relevance factor can be based on the user's direct or implied input. For example, the user can inquire directly about a TV when the system identifies several electronic devices in an image, thus making the TV a relevant object. Also, the user's past communication data, for example, talking about a weekend road trip while driving in device 202, can be used to infer a gas station can be a relevant object.

According to some embodiments, a relevance factor can be predetermined by a system administrator or a third-party administrator. For example, a third-party domain provider, e.g., a gas station owner or a gas station advertiser, can define a virtual object corresponding to the gas station as relevant for marketing and promoting purposes. In addition, the third-party domain provider can configure a customized domain database 224 so that it can provide marketing/promoting information to the user via the AR marking. For example, customized domain database 224 can store pricing information such as gas prices and ongoing special deals, which can be provided to the user during an interaction session.

As shown in FIG. 2, according to some embodiments, following the determining of a relevant object, a module for virtual rendering 220 can generate and overlay text indicating a corresponding key phrase, or an AR marker, next to but not overlapping the relevant object. The superimposed text can appear to be “anchored” to the virtual object in the image, meaning it can dynamically change its location and appearance according to the user's perspective. According to some embodiments, multiple corresponding key phrases can be dynamically generated for multiple relevant objects based on a determined type of the virtual object. According to some embodiments, a corresponding key phrase is a predetermined wake-up phrase, e.g., “OK, book” or “OK, gas station.”

Device 202 can comprise one or more microphones that are configured to receive voice commands of a user and generate audio data based on the voice queries for speech recognition. Such audio data can comprise time-series measurements, such as time series pressure fluctuation measurements and/or time series frequency spectrum measurements. For example, one or more channels of Pulse Code Modulation (PCM) data may be captured at a predefined sampling rate where each sample is represented by a predefined number of bits. Audio data may be processed following capture, for example, by filtering in one or more of the time and frequency domains, by applying beamforming and noise reduction, and/or by normalization. In one case, audio data may be converted into measurements over time in the frequency domain by performing the Fast Fourier Transform to create one or more frames of spectrogram data. According to some embodiments, filter banks may be applied to determine values for one or more frequency domain features, such as Mel-Frequency Cepstral Coefficients. Audio data as described herein for speech recognition may comprise a measurement made within an audio processing pipeline.

Upon receiving a user's speech audio data, speech recognition system 226 can infer the corresponding key phase associated with a relevant object. Speech recognition system 226 can comprise an Automatic Speech Recognition (ASR) and natural language understanding (NLU) system that is configured to infer at least one semantic meaning of a voice command based on various statistical acoustic and language models and, optionally, grammars. According to some embodiments, speech recognition system 226 can comprise at least one network interface 228, acoustic model 230, language model 232, and disambiguation 234.

Acoustic model 230 can be a statistical model that is based on hidden Markov models and/or neural network models, which are configured to infer the probabilities of phonemes in query audio. Examples of such acoustic models comprise convolutional neural networks (CNN) and recurrent neural networks (RNN) such as long short-term memory (LSTM) neural networks or gated recurrent units (GRU) and deep feed-forward neural networks. Phoneme probabilities are output from the speech recognition system 226 can be subject to word tokenization and statistical analysis by language model 232 to create transcriptions. The transcriptions can be interpreted based on grammars or neural models to determine its semantic meaning. Accordingly, when the system determines that the inferred semantic meaning of the voice command matches a corresponding key phrase, e.g., “OK, gas station,” an interactive session related to the identified relevant object, i.e., gas station, is established.

Upon establishment of the interaction session, interaction session 222 can, for example, provide one or more suggested queries based on the available data entries from databases. For example, when the user indicates he/she is interested in learning more about the gas station by saying “OK, gas station”, the system can retrieve relevant marketing data stored in a customized domain database and propose several questions related to the marketing data. For example, the proposed questions can be “what is the gasoline price today?” or “what is on sale?”

According to some embodiments, during an interaction session, a user can use speech to ask questions and obtain answers regarding the identified object. For example, the user can ask, “what is on sale in the gas station?” Based on the inferred semantic meaning of the question, the system can provide a response regarding the items on sale, via, for example, synthesized speech or via text shown on a display of device 202. Such a speech-enabled virtual object interaction can be flexible, natural, and convenient.

According to some embodiments, after receiving a voice query from the user, speech recognition system 226 can determine that the query is ambiguous. For example, the user asks, “what is the gasoline price in this gas station?” without specifying which octane rating of gasoline in which he/she is interested. To provide a clear answer to the user, a module for disambiguation 234 can generate one more disambiguating questions and provide it to the user. For example, the system can ask or show, “which type of gasoline do you want?” According to some embodiments, the disambiguating questions can be generated based on the type or attributes of the identified virtual object or based on the available data entries of the object.

According to some embodiments, augmented reality system 212 can continuously track and/or reconstruct virtual objects via image processing by the device over a period of time. According to some embodiments, the system only activates the tracking and/or reconstructing process upon the instruction of the user. This saves computational resources, because image processing can requires substantial processing power and memory. But the user experience aspect is more important. The overlay of AR information can be distracting to the user, particularly when it is not being used for the user's immediate purpose. Hence it is beneficial to give the user flexible control over the activation/deactivation of the AR display.

According to some embodiments, augmented reality system 212 and speech recognition system 226 can be implemented remotely by processors in a host server in a cloud-based processing structure. It is also possible for each component functions to be run in one or another system, both systems, or to have a single server-based system for all component functions. Alternatively, at least partial functions of augmented reality system 212 and speech recognition system 226, such as object registration 216, virtual rendering 220, disambiguation 234, can be implemented by device 202.

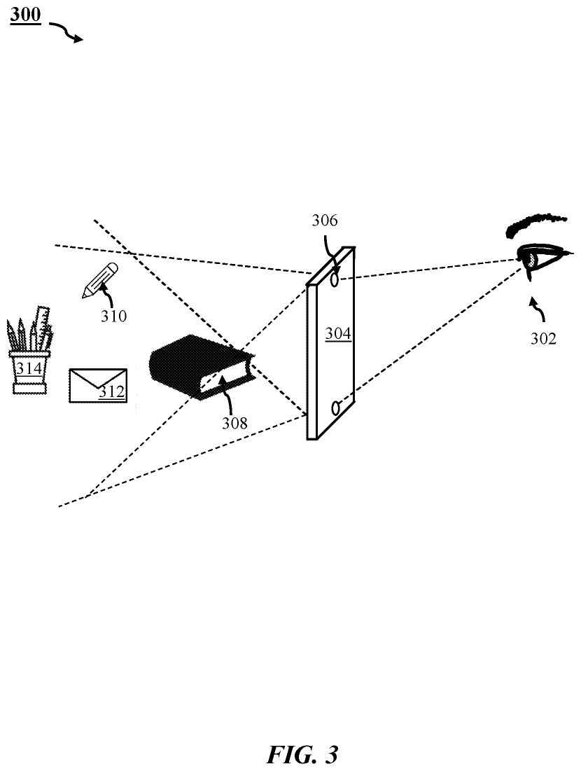

FIG. 3 shows an example 300 in which a computing device is configured to implement an AR inquiry mode. According to some embodiments, a user 302 can indicate to a mobile device 304 to activate an AR inquiry mode. Such an indication can be either direct or implied, as explained herein.

For example, user 302 can use a voice command, e.g., “look around,” to initialize the AR inquiry mode by scanning the visual surroundings with mobile device 304. Accordingly, mobile device 304 can turn on its one or more cameras 306 for capturing an image or a stream of images for the user's surroundings. In another example, user 302 can use a gesture command to activate the AR inquiry mode. In another example, the user can activate the AR mode by manually clicking a button on mobile device 304. In yet another example, user 302 can open an AR inquiry application and point/shoot at real-world objects that he/she wishes to find more about and interact with.

According to some embodiments, mobile device 304 can receive an implied user intention for activating an AR inquiry mode. Alternatively, a system can infer a user's likelihood of interest in a real-world object, and thus automatically activate the AR inquiry mode.

According to some embodiments, device 304 can receive direct user input to terminate an AR inquiry mode. For example, a user can use a voice command, e.g., an audio cue such as “stop looking,” “stop scanning,” or “stop AR,” to end the AR inquiry mode. For example, the user can use a gesture command to conclude the AR inquiry mode. Accordingly, device 304 is configured to turn off its camera(s) or cease the AR processing.

According to some embodiments, device 304 can receive an implied user intention to deactivate an AR inquiry mode. For example, the user can initiate another application on device 304, which can automatically deactivate or overwrite the AR inquiry process. For example, a lack of user input or feedback for a predetermined amount of time can be used to terminate the AR inquiry process via a timeout mechanism. According to some embodiments, the predetermined amount of time can be configurable by the system administrator or the user.

According to some embodiments, once the AR inquiry mode is activated, mobile device 304 can capture real-world image data, for physical objects within the field of view of the cameras. Examples of such physical objects can be a book 306, a letter 314, a pencil 310, and an organizer 314.

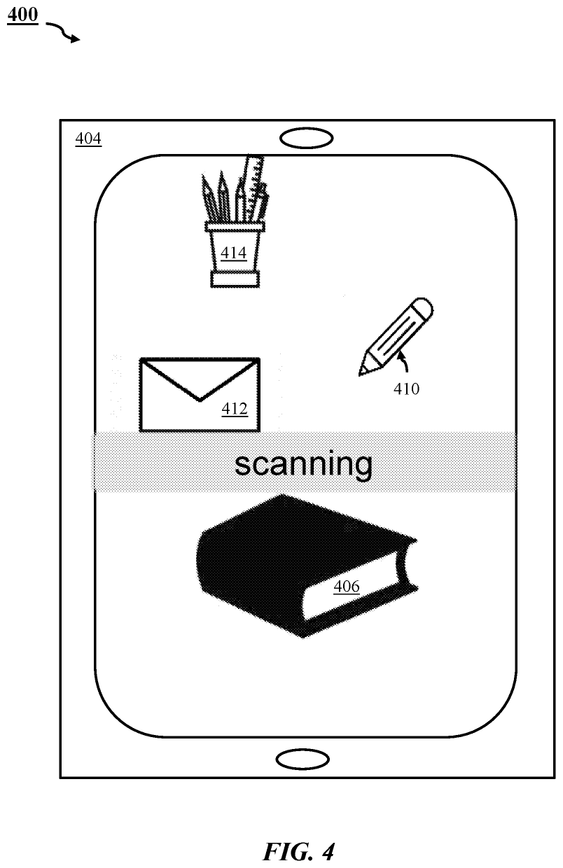

FIG. 4 shows a scanning process 400 of the mobile device 404 as shown on a display. Upon capturing the real-world image data, an object registration module is configured to scan the surroundings, recognize and identify one or more virtual objects in the image data. In this process, the system can track, recognize and associate 3-D physical objects in real-world to 2-D virtual objects identified in the images. As discussed herein, various object detection, object recognition and image segmentation in computer visions can be utilized.

As shown in scanning process 400, mobile device 404 can recognize a variety of virtual objects, including a book 406, a letter 412, a pencil 410, and an organizer 414 within the view of the camera(s) during a scanning process. According to some embodiments, mobile device 404 can retrieve and/or calculate the location data of the identified virtual objects. According to some embodiments, mobile device 404 can determine the relative positions of the virtual objects in relation to the mobile device 404.

For example, various sensors, e.g., cameras, radar/lidar modules, or proximity sensors, can determine a distance between the identified virtual objects and mobile device 404. Furthermore, sensors such as cameras, accelerometers, gyroscopes can determine a speed and direction of mobile device 404 relative to a frame or reference. According to some embodiments, the system can conclude that book 406 is closer than other objects such as letter 412 and pencil 410.

According to some embodiments, the system can further determine the type of the identified virtual object. For example, mobile device 404 can retrieve attributes associated with book 406, letter 412, pencil 410, and organizer 414. Based on the determined type of object, the system can retrieve relevant data from relevant object databases. For example, the system can retrieve information related to book 406 from a book review database and retrieve information related to letter 412 from a customized database by an office supplier.

According to some embodiments, a system can identify generic types of objects such as a book or pencil and then invoke further functions to identify species such as a book with a specific title. According to some embodiments, a further function can identify unique instances of objects such as a letter from a specific sender to a specific recipient sent on a specific date. A hierarchy of levels of functions allows for a general training of models for high level discrimination of object classes, which is more efficient than expert design of systems for class-level object recognition. However, it allows for expert-designed class-specific recognition functions. Such functions can be created by third-parties with domain expertise. For example, a postal service could create a function for identifying letters and their attributes such as sender, recipient, and date whereas a book seller could create a function for identifying title, author, and ISBN number of books. An AR system that creates an ecosystem for third parties has the reinforcing benefits of enabling third party participants to capture the attention of a larger number of system users and enabling system end users to experience recognition of more object types and a richer and more engaging experience.

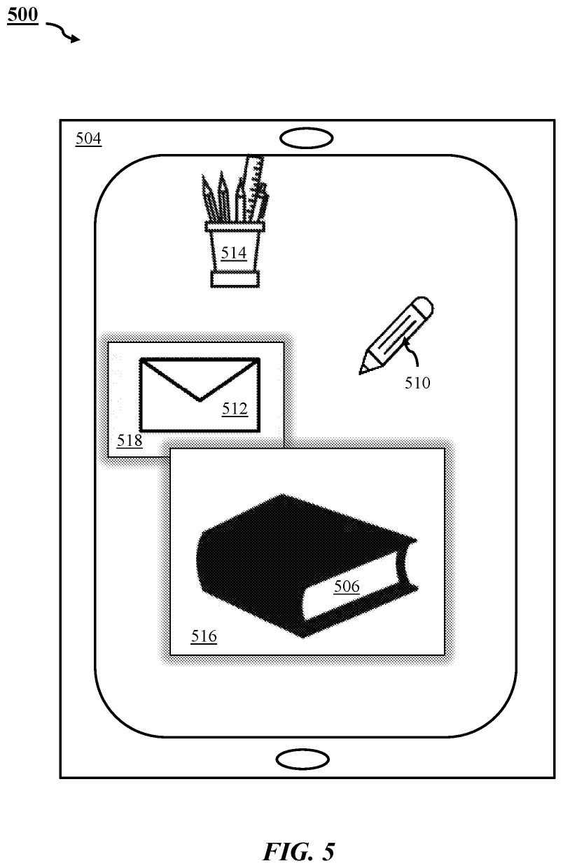

FIG. 5 shows an identifying process 500 for determining relevant objects as shown on a display of mobile device 504. According to some embodiments, following the identification of book 506, letter 512, pencil 510, and organizer 514, the system can determine or suggest relevant objects from AR markings, thus avoiding AR marking for unnecessary, irrelevant objects to save computing power.

According to some embodiments, an object's relevance can be determined by the availability of data associated with this object. For example, following identifying book 506, letter 512, pencil 510, and organizer 513, the system can send data requests for all objects to various object-relevant databases. If the system only receives data for book 506 and letter 512, the system can mark book 506 as a first relevant object 516, and letter 512 as a second relevant object 518. The system skips marking pencil 510 and organizer 514 as it does not have any relevant data to provide to the user.

According to some embodiments, an object's relevance can be determined by a relevance factor. According to some embodiments, the system can adopt a relevance model based on one or more relevance factors that can be associated with different weights. The output of the relevance model can be a probability that the user will interact with the virtual object. According to some embodiments, the system can determine one or more relevant objects with respective probabilities exceeding one or more predetermined thresholds.

According to some embodiments, one relevance factor can be position data indicating a position of the virtual object relative to mobile device 504. For example, various sensors, such as cameras, radar modules, LiDAR sensors, proximity sensors, can determine the distance between the virtual object and mobile device 504. Furthermore, sensors such as cameras, accelerometers, gyroscopes can determine the speed, direction and/or orientation of the client device. According to some embodiments, the system can conclude that book 506 and letter 512 are closer than pencil 512 and organizer 514, thus making them relevant objects for the AR marking.

According to some embodiments, a relevance factor can be the user's gesture data such as tracked viewpoint, head motion, or body movement. For example, motion tracking sensors such as gyroscopes, accelerometers, magnetometers, radar modules, LiDAR sensors, proximity sensors, etc., can collect the user's head motion or body movement. Additionally, the eye-tracking sensors and cameras can determine the user's line of sight in real-time. For example, if a user's eyesight is fixed on letter 512 for a predetermined amount of time, the system can conclude letter 512 has high relevance to the user. Similarly, if the user walks towards book 506 (gesture data), the system can determine book 506 has high relevance for further AR processing.

According to some embodiments, a relevance factor can be based on the user's direct or implied input. For example, the user can tap on the region containing book 516 in the display screen of device 504 to indicate that the book is a relevant object that he/she would like to ask questions about. Alternatively, the user can inquire about book 506 via a voice query, e.g., “Who is the author of this book?” Also, the user's past communication data, for example, talking about a book, can be used to infer book 506 can be a relevant object.

According to some embodiments, natural language grammars can be associated with object types. A system can have a plurality of grammars that are associated with various types of objects that the system can recognize. However, when interpreting words spoken about a visual scene, the system will increase the weight of restrictive parsing spoken words according to grammars associated with objects determined to be relevant or have a have high relevance factor.

According to some embodiments, a relevance factor can be predetermined by a system administrator or a third-party administrator. For example, the system can be configured to always present a book for sale as a relevant object. In addition, a customized domain database can be configured to provide marketing/promoting information to the user during an AR interaction session regarding book 506.

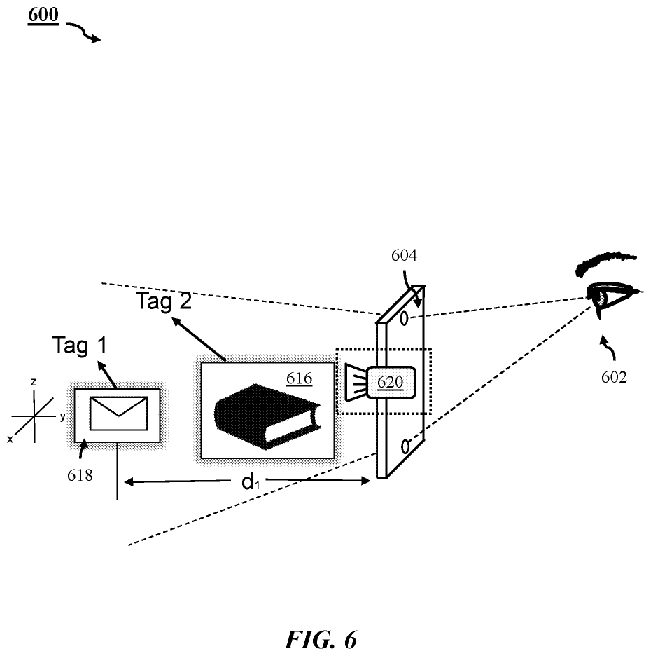

FIG. 6 shows a tagging process 600 of the determined relevant objects, according to one or more embodiments of the present subject matter. According to some embodiments, an AR tag can be used to facilitate the marking of the relevant objects with a key phrase or a marker as described herein. As described herein, various sensors of client device 604 can be used to continuously track the relative position and orientation between, for example, book 616 and client device 604, and determine a real-time viewpoint of user 602. Accordingly, as shown in FIG. 6, AR Tag 2 can comprise the real-time position data of book 616 relative to client device 604. Based on such tag information, a virtual camera 620 can be simulated to be placed at the same point of client device 604, which can generate text indicating a key phrase at the tagged position. Similarly, AR Tag 1 can comprise real-time position data, e.g., distance d₁, of letter 618 relative to client device 604, which can be used to generate text indicating a key phrase at the tagged position.

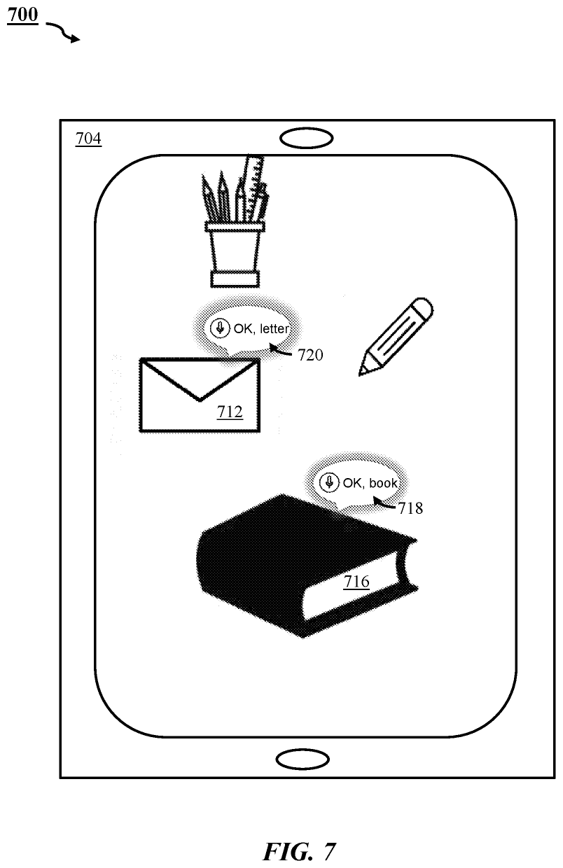

FIG. 7 shows examples 700 of corresponding key phrases that can be associated with identified relevant objects, according to one or more embodiments of the present subject matter. According to some embodiments, a corresponding key phrase of each relevant object can be a predetermined wake-up phrase. For example, a key phrase for book 716 can be “OK, book” (718), whereas a key phrase for letter 712 can be “OK, letter” (720). According to some embodiments, a corresponding key phrase can be undefined. For example, a key phrase can be any phrase that mentions the word “book” or “letter”. In addition, as shown in FIG. 7, a key phrase can comprise a microphone icon to invite a voice input from the user.

According to some embodiments, based on the tracked user viewpoint data, e.g. AR tags, a rendering of the text indicating a key phrase can be shown as “anchored” to the relevant object in the image, meaning the text can change its position and appearance based on a view point of the user. Furthermore, if the tagging process is continuous, the rendering of the text can be adjusted in real-time.

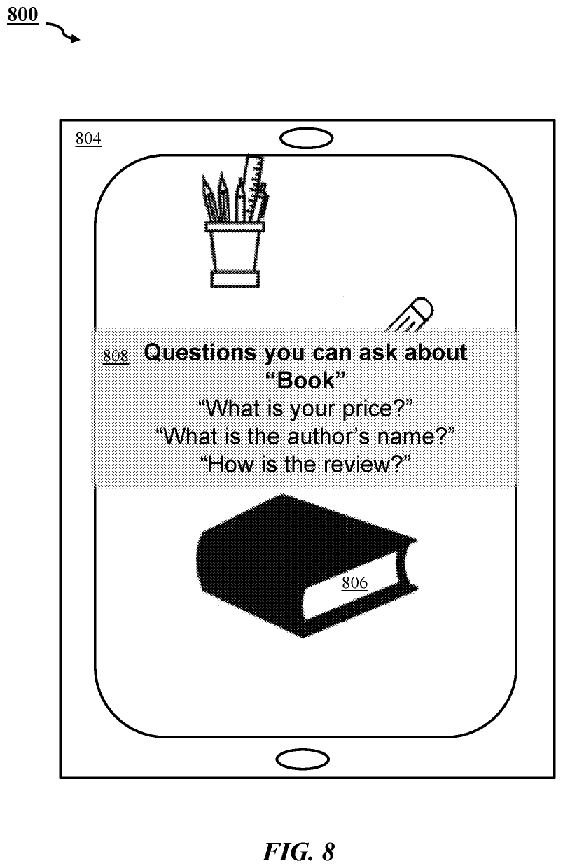

FIG. 8 shows exemplary questions 800 for a selected object that has been confirmed by the user. After receiving speech audio from a user, the system can infer the key phrase of “OK, book” as described herein. Accordingly, the system can enable an interaction session wherein the user can interact with virtual book 806. According to some embodiments, the system can propose some exemplary questions 808 regarding virtual book 806. Such suggested queries can be based on available data entries from the database. For example, when the user confirms his/her interest by saying “OK, book”, the system can retrieve information such as the book price, author's name and reviews related to the identified book. Based on such information, it can propose questions related to the book price, author, and reviews. Accordingly, during the interaction section, the user can communicate with mobile device 804 via the voice interface to obtain information related to virtual book 806.

For devices that can be freely rotated such as glasses on a user's head or a mobile phone in moving hands, an object that moves out of view is likely to come back into view when the device is rotated back. According to some embodiments, a system can store a cache of information about recently identified objects. When performing object recognition, the probability of a hypothesized object or object class can be increased if the object or an object of the hypothesized class is present or prestored within the cache. This improves the speed and accuracy of object recognition. Objects or object classes stored in the cache can be discarded when it is unlikely that the user will bring the object or an object in the class back into view. This could be implemented via a timeout or any reasonable mechanism to determine that a change of context has occurred.

By using the location of objects within a view and detecting motion within successive images captured by a camera or by using other motion sensors and, optionally, distance estimate cs, some systems can build a 3D model of objects in the vicinity of the user. These can be used to further improve accuracy of object recognition. Furthermore, according to some embodiments, the system will show text of key phrases anchored to the edge of a display nearest an unseen object in the space outside of the camera view. This improves the user experience by allowing the user to interact with high relevance objects in the vicinity without a need to physically orient a device to have them in view.

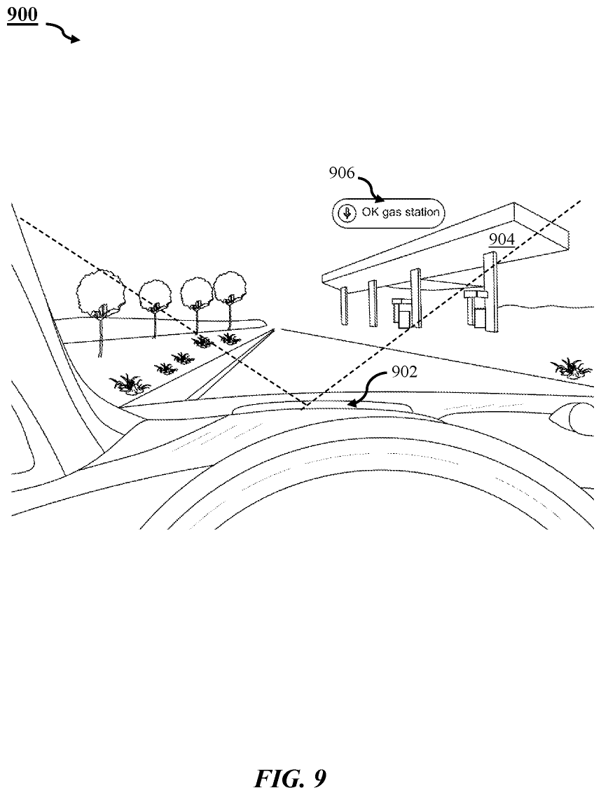

FIG. 9 shows a first person view 900 in which an automobile is configured to implement an AR inquiry mode via a head-up display (HUD) 902. With the optical see-through technologies, a HUD system can project virtual information on the car's transparent windshield. The HUD system can enable non-distracted driving because the driver does not need to take his/her eyes off of the road. The HUD system can comprise one or more light sources (not shown) and optical elements that can direct light toward the driver's eyes. The virtual content that can be projected by the HUD system can comprise the car's speed, road condition warning, messages, or anything useful for the driver, etc., which can be superimposed on real-world 3D objects.

According to some embodiments, a system configured to implement an AR mode of the smart car can receive a stream of images for the surrounding environment via its embedded cameras. Such image data can be processed in real-time for object registration, which can recognize and identify one or more virtual objects in the image data. In this process, the system can recognize and associate physical objects in real-world to virtual objects. For example, object registration can use feature detection, edge detection, or other image processing methods to interpret the camera images. Various object detection, object recognition and image segmentation in computer visions can be utilized.

In this example, the system can recognize a gas station virtual object in the image data, which corresponds to a real-world, physical gas station 904 nearby. Based on a relevance factor as described herein, the system can determine that the gas station virtual object is a relevant virtual object. Another example of such a relevance factor can comprise the driver's previous discussion of planning a weekend road trip, or preassigned relevancy by a system administrator or third-party advertiser. While the automobile approaches the physical gas station 904, the HUD system can project an image of text of a key phrase or wake-up phrase 906, e.g., “OK, gas station” on the windshield at a position corresponding to the physical gas station 904. The projected image of the key phrase can be non-intrusive so that it does not distract the driver.

Furthermore, a microphone icon can be shown with key phrase 906 for inviting a speech-enabled interaction with the driver.

To interact with the speech-enabled AR system, the user can say “OK, gas station” to activate the interaction. Upon receiving the speech audio and inferring its meaning, the system can enable a speech-enabled interaction with the driver. For example, the user can acquire additional information regarding physical gas station 904 by asking questions and receiving answers by synthesized speech. This hand-free approach can prevent the driver from being distracted from taking his/her hands from the wheel and taking his/her eyes from the road.

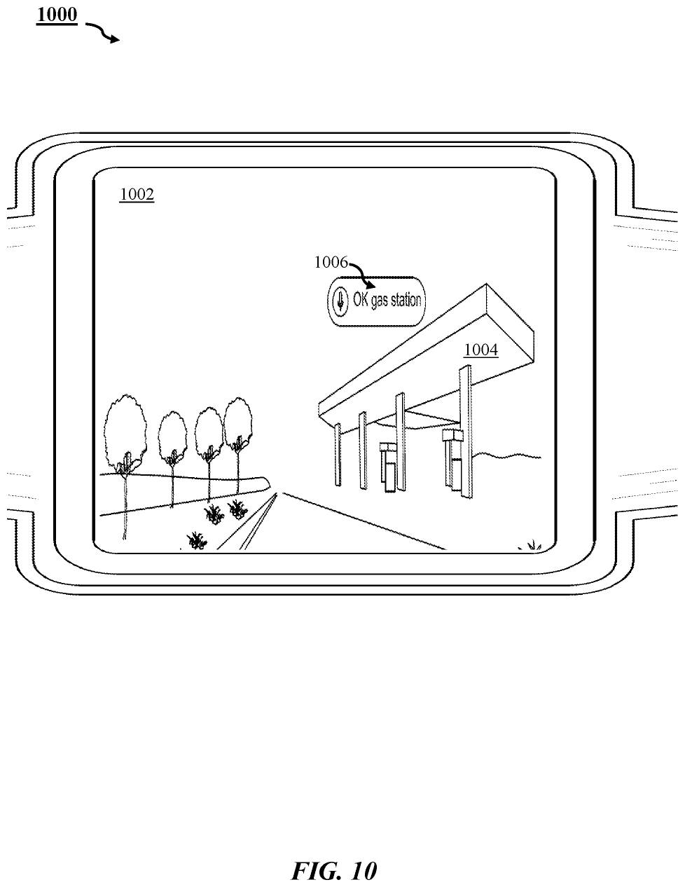

FIG. 10 shows another first-person view 1000 in which an automobile is configured to implement an AR inquiry mode via a dashboard display. A dashboard display can show a stream of images from the surrounding environment, which can be captured by the car's embedded cameras. In this example, display 1002 is a captured real-time view from the driver's car.

Such image data can be processed in real-time for object registration as described herein. For example, the speech-enabled AR system can recognize a gas station virtual object 1004 in the image data, which corresponds to a real-world, physical gas station nearby. According to some embodiments, the system can retrieve location data of the identified gas station virtual object 1004, which can be utilized to determine, for example, the relevancy of the object, the available virtual content related to the object, etc.

Based on a relevance factor, as described herein, the system can determine that gas station virtual object 1004 is a relevant virtual object. While the automobile approaches the physical gas station, the system can show text indicating a key phrase or wake-up phrase 1006, e.g., “OK, gas station” on the dashboard display at a position corresponding to gas station virtual object 1004. Furthermore, a microphone icon can be shown with key phrase 1006 for inviting a speech-enabled interaction with the driver.

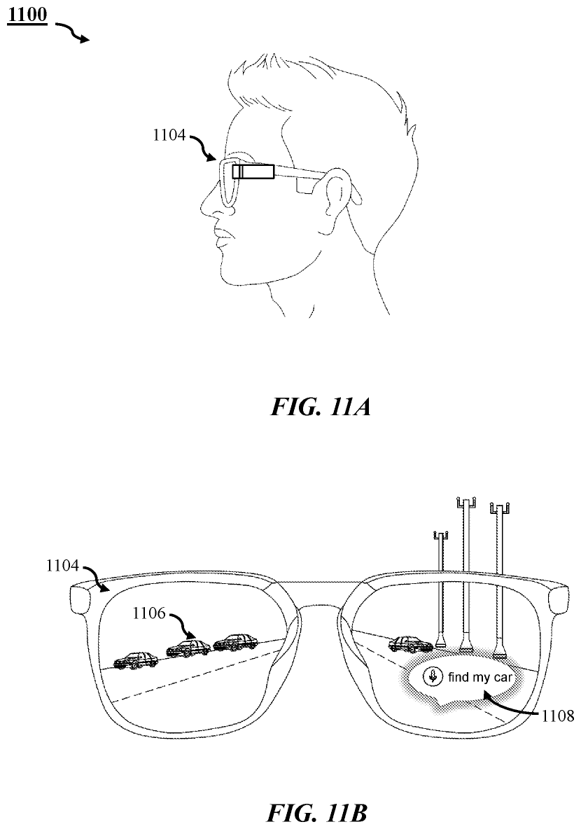

FIG. 11A and 11B show an example in which smart glasses 1104 are configured to implement an AR inquiry mode. According to some embodiments, as shown in FIG. 11A, smart glass 1104 can adopt an optical see-through head mount display for implementing the present subject matter. Such a head-mount display can immersively enrich the user's visual perception of the real physical world with virtual content. Various sensors can be embedded into smart glass 1104 to track the user's viewpoint, gestures and activities. Smart glass 1104 can further comprise microphone(s) and speaker(s) to implement speech-enabled interaction with the user.

According to some embodiments, the user can provide explicit user input to activate an AR inquiry mode of smart glass 1104 by providing, for example, a voice command of “look around”. Upon receiving the audio signal and inferring its meaning, the speech-enabled AR system can turn on camera(s) and capture a stream of images for the user's surroundings. Another explicit user input can be a swipe of a hand or other pre-defined gesture to activate the AR inquiry mode.

According to some embodiments, implied user intention can be used to activate an AR inquiry mode. The speech-enabled AR system can infer a user's likelihood of interest in a real-world object and thus automatically activate the AR inquiry mode when it detects the user reaching proximity of the real-world object. For example, as shown in FIG. 11B, when a user is near a bunch of cars, e.g., 1106, the system can infer, based on the tracked activity data of the user, that the user is probably looking for his/her car. As a result, the AR system can overlay text of a key phrase or wake-up phrase on the glass to invite the user to activate an AR inquiry mode. Furthermore, the key phase can be dynamically generated based on the situation. For example, the key phrase to activate an inquiry mode can be “find my car.”

Upon receiving a user's voice command of “find my car”, the AR system can retrieve the tracked parking location of the car and further cast a guided virtual path on top of real roads through smart glass 1104. According to some embodiments, the system can also use synthesized speech to interact and guide the user to find the car.

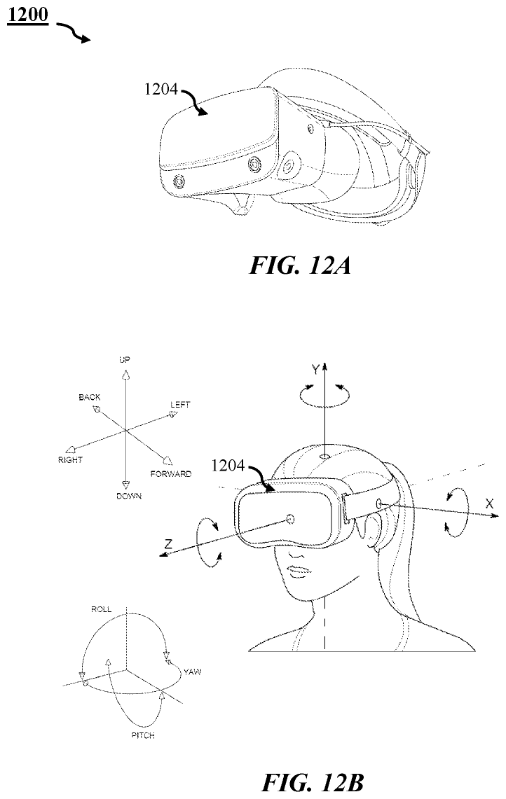

FIGS. 12A and 12B show an example 1200 in which a head mount AR device 1204 is configured to implement an AR inquiry mode. FIG. 12A is a perspective view of a head mount AR device 1204 configured to implement the speech-enabled AR inquiry mode. The head mount AR device 1204 can comprise an optical head-mounted display that reflects projected images while allowing the user to see through it. Head mount AR device 1204 can comprise microphones and/or speakers for enabling the speech-enabled interface of the device.

According to some embodiments, head mount AR device 1204 can comprise head motion or body movement tracking sensors such as gyroscopes, accelerometers, magnetometers, radar modules, LiDAR sensors, proximity sensors, etc. Additionally, the device can comprise eye- tracking sensors and cameras. As described herein, during the AR inquiry mode, these sensors can individually and collectively monitor and collect the user's physical state, such as the user's head movement, eye movement, body movement, facial expression, etc.

FIG. 12B is an exemplary view of a user using head mount AR device 1204 for the speech-enabled AR. As shown in FIG. 12A, head mount AR device 1204 can measure motion and orientation in six degrees of freedom (6 DOF) with sensors such as accelerometers and gyroscopes. As shown in FIG. 12B, according to some embodiments, the gyroscope can measure rotational data along the three-dimensional X-axis (pitch), Y-axis (yaw), and Z-axis (roll). According to some embodiments, the accelerometer can measure translational or motion data along the three-dimensional X-axis (forward-back), Y-axis(up-down), and Z-axis(right-left). The magnetometer can measure which direction the user is facing. As described herein, such data can be processed to determine, for example, the user's implied instruction to activate an AR inquiry mode, the user's real-time viewpoint, the relevancy of a virtual object, and the dynamic rendering of the virtual content, etc.

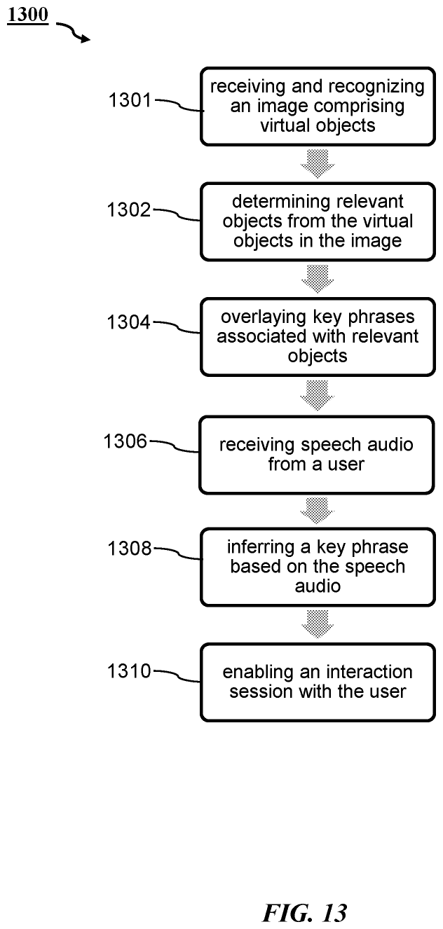

FIG. 13 is an exemplary flow diagram 1300 illustrating the aspect of a method having features consistent with some implementations of the present subject matter. At step 1301, the speech-enabled AR system can receive real-world image data via one or more cameras, identify visual objects in images and recognize virtual objects corresponding to the visual objects. The system can utilize various image processing methods to identify these objects.

According to some embodiments, the system can retrieve and/or calculate location data of identified virtual objects. For example, a device can retrieve its real-time GPS coordinates and use it as the estimated GPS location of the virtual object.

According to some embodiments, the system can determine a type or class of the virtual object, e.g., a building, a book, a gas station. For example, the object registration module can retrieve attributes associated with the virtual object. The object registration module can also extract natural features of the virtual object to determine its type, e.g., a building or a book. Based on a determined type of the virtual object, the system can retrieve relevant data from one or more corresponding object databases. For example, the system can retrieve information related to a gas station from a customized domain database.

At step 1302, the system can determine or suggest a relevant object from the identified virtual objects. For example, a relevance score can be assigned to each identified virtual object. This process can generate AR marking for potentially relevant virtual objects, thus avoiding AR marking for unnecessary, irrelevant objects.

According to some embodiments, object relevance can be determined by the availability of data associated with an object. For example, for identified virtual objects A, B, and C, if it only receives data for object A, the system can mark object A as a relevant object and generate AR marking for it.

According to some embodiments, object relevance can be determined by a relevance factor indicating an estimated probability that the user will be interested in a virtual object. According to some embodiments, the augmented reality system can adopt a relevance model based on one or more relevance factors. The output of the relevance model can be a probability that the user will interact with the virtual object. According to some embodiments, the system can determine one or more relevant objects with respective probability exceeding a predetermined threshold.

According to some embodiments, a relevance factor can be location data, e.g., GPS or other location-tracking techniques, as described herein. According to some embodiments, a relevance factor can be position data indicating a position and orientation of the virtual object relative to the device. For example, the system can conclude that a first virtual object is more likely to be a relevant object because it is closer to the device than a second virtual object. Similarly, the system can determine an object has high relevance if the front side of the device is facing forward toward it.

According to some embodiments, a relevance factor can be the user's gesture data, such as tracked viewpoint or movement. For example, if a user's eye is fixed on a virtual object for a predetermined amount of time, the system can conclude the object has high relevance to the user. Similarly, if the user walks towards a virtual object (gesture data), the system can determine the object has high relevance for further AR processing.

According to some embodiments, a relevance factor can be based on the user's direct or implied input. For example, the user can tap on a virtual object to provide direct input showing his/her interest. According to some embodiments, a relevance factor can be predetermined by a system administrator or a third-party administrator.

At step 1304, the speech-enabled AR system can generate and overlay text indicating a corresponding key phrase next to the relevant objects. The superimposed text can appear to be “anchored” to the virtual object in the image, meaning it can dynamically change its location and appearance according to the user's perspective. According to some embodiments, multiple corresponding key phrases can be generated for multiple relevant objects. According to some embodiments, a corresponding key phrase is a predetermined wake-up phrase, e.g., “OK, book” or “OK, gas station.”

At step 1306, the system can receive speech audio from the user. The device can comprise one or more microphones that are configured to receive voice commands of the user and generate audio data based on the voice queries for speech recognition.

At step 1308, the system can infer the semantic meaning of the corresponding key phase via a natural language understanding system. The natural language understanding system can comprise an ASR and NLU system that is configured to infer at least one semantic meaning of a voice command based on one or more of statistical acoustic and language models and grammars.

At step 1310, when the system determines that the inferred semantic meaning of the voice command matches a corresponding key phrase, e.g., “OK, gas station,” an interaction session related to the identified relevant object, i.e., gas station, can be established.

Upon establishment of the interaction session, the system can, for example, provide one or more suggested queries based on the available data entries from databases. For example, when the user indicates he/she is interested in learning more about the gas station by saying “OK, gas station,” the system can retrieve relevant marketing data stored in a customized domain database and propose several questions related to the marketing data. For example, the proposed questions can be “what is the gasoline price today?” or “what is on sale?”

According to some embodiments, during an interaction session, a user can use speech to ask questions and obtain answers regarding the identified object. For example, the user can ask, “what is on sale in the gas station?” Based on the inferred semantic meaning of the question, the system can provide a response regarding the items on sale, via, for example, synthesized speech or via texts shown on a display of the device.

According to some embodiments, after receiving a voice query from a user, the system can determine that the query is ambiguous. For example, the user asks, “what is the gasoline price in this gas station?” without specifying which octane rating of gasoline he/she is interested. The system can generate one more disambiguating question and provide it to the user. For example, the system can ask or show, “which type of gasoline do you want?” According to some embodiments, the disambiguating questions can be generated based on the type or attributes of the identified virtual object or based on the available data entries of the object.

According to some embodiments, the speech-enabled AR system can be implemented remotely by processors in a host server in a cloud-based processing structure. Alternatively, at least partial functions of the speech-enabled AR system can be implemented locally by the device.

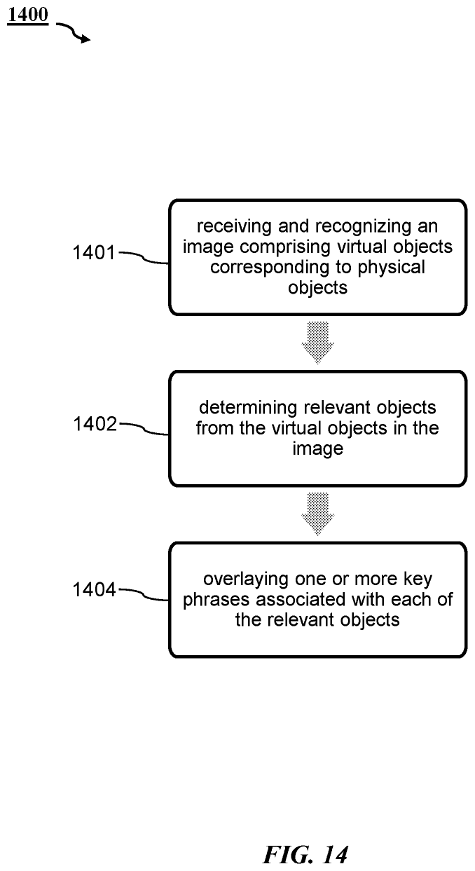

FIG. 14 is another exemplary flow diagram 1400 illustrating aspects of a method having features consistent with some implementations of the present subject matter. At step 1401, the speech-enabled AR system can receive real-world image data via one or more cameras and recognize virtual objects in the image data. For example, the system can utilize various image processing methods to identify these objects.

At step 1402, the system can determine or suggest a relevant object from the identified virtual objects. According to some embodiments, object relevance can be determined by a relevance factor indicating an estimated probability that the user will be interested in a virtual object. According to some embodiments, the augmented reality system can adopt a relevance model based on one or more relevance factors. According to some embodiments, the system can determine one or more relevant objects with respective probability exceeding a predetermined threshold.

At step 1404, the speech-enabled AR system can generate and overlay text indicating a corresponding key phrase next to the relevant objects. According to some embodiments, multiple corresponding key phrases can be generated for multiple relevant objects. Accordingly, a user, by speaking of the corresponding key phrase, can initiate a speech-enabled interaction session with the virtual object that is associated with the key phrase.

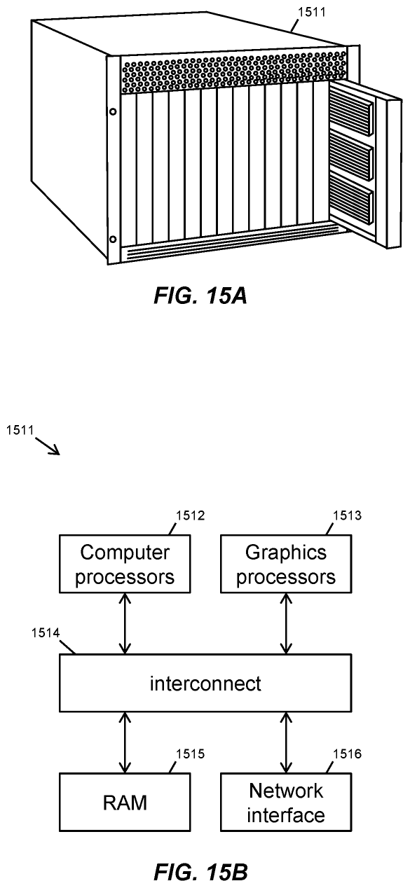

FIG. 15A shows a picture of a server system 1511 in a data center with multiple blades that can be used to implement one or multiple aspects of the present subject matter. For example, server system 1511 can host one or more applications related to a speech-enabled AR system and/or a speech recognition system. FIG. 15B is a block diagram of functionality in server systems that can be useful for managing the speech-enabled interaction session. Server system 1511 comprises one or more clusters of central processing units (CPU) 1512 and one or more clusters of graphics processing units (GPU) 1513. Various implementations may use either or both of CPUs and GPUs.

The CPUs 1512 and GPUs 1513 are connected through an interconnect 1514 to random access memory (RAM) devices 1515. RAM devices can store temporary data values, software instructions for CPUs and GPUs, parameter values of neural networks or other models, audio data, operating system software, and other data necessary for system operation.

The server system 1511 further comprises a network interface 1516 connected to the interconnect 1514. The network interface 1516 transmits and receives data from client devices and host devices.

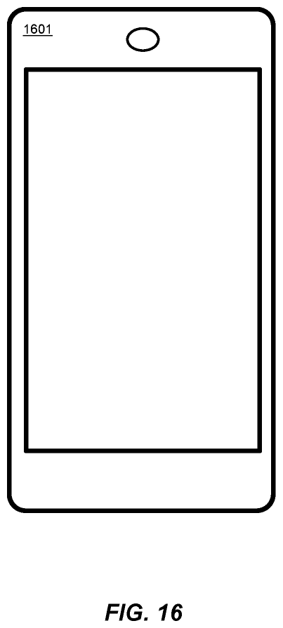

As described above, many types of devices may be used to provide speech-controlled AR interface. FIG. 16 shows a mobile phone as an example. Other devices can be a smart car, a head mount AR headset, and smart glasses, a tablet computer, or any combination thereof. Mobile device 1601 can have at least one microphone and at least one camera as I/O (input/output) devices. Mobile device 1601 can implement some functions of the speech-enabled AR system. For example, mobile device 1601 can include a speech recognition system that can translate speech audio into a computer-readable format such as a text transcription or intent data structure.

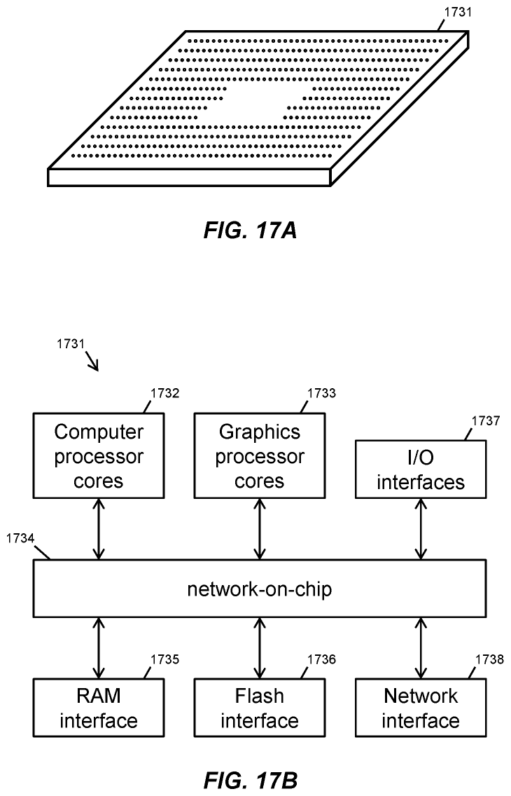

Many embedded devices, edge devices, IoT devices, mobile devices, and other devices with direct user interfaces are controlled and have speech-enabled AR systems performed by system-on-a-chip (SoCs). SoCs have integrated processors and tens or hundreds of interfaces to control device functions. FIG. 17A shows the bottom side of a packaged system-on-chip device 1731 with a ball grid array for surface-mount soldering to a printed circuit board. Various package shapes and sizes can be utilized for various SoC implementations.

FIG. 17B shows a block diagram of the system-on-chip 1731. It comprises a multicore cluster of CPU cores 1732 and a multicore cluster of GPU cores 1733. The processors connect through a network-on-chip 1734 to an off-chip dynamic random access memory (DRAM) interface 1735 for volatile program and data storage and a Flash interface 1736 for non-volatile storage of computer program code in a Flash RAM non-transitory computer readable medium. SoC 1731 may also have a display interface (not shown) for showing an AR-enhanced graphical user interface to a user or showing the results of a virtual assistant command and an I/O interface module 1737 for connecting to various I/O interface devices, as needed for different peripheral devices. The I/O interface enables sensors such as touch screen sensors, geolocation receivers, microphones, speakers, Bluetooth peripherals, and USB devices, such as keyboards and mice, among others. SoC 1731 also comprises a network interface 1738 to allow the processors to access the Internet through wired or wireless connections such as WiFi, 3G, 4G long-term evolution (LTE), 5G, and other wireless interface standard radios as well as Ethernet connection hardware. By executing instructions stored in RAM devices through interface 1735 or Flash devices through interface 1736, the CPUs 1732 and GPUs 1733 perform steps of methods as described herein.

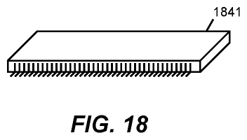

Program code, data, audio data, operating system code, and other necessary data are stored by non-transitory computer-readable media. FIG. 18 shows an example computer readable medium 1841 that is a Flash random access memory (RAM) chip. Data centers commonly use Flash memory to store data and code for server processors. Mobile devices commonly use Flash memory to store data and code for processors within SoCs. Non-transitory computer readable medium 1841 stores code comprising instructions that, if executed by one or more computers, would cause the computers to perform steps of methods described herein. Other digital data storage media can be appropriate in various applications.

Examples shown and described use certain spoken languages. Various implementations operate, similarly, for other languages or combinations of languages. Some embodiments are mobile, such as an automobile. Some embodiments are portable, such as a mobile phone. Some embodiments comprise manual interfaces such as keyboards or touchscreens. Some embodiments function by running software on general-purpose CPUs such as ones with ARM or x86 architectures. Some implementations use arrays of GPUs.

Several aspects of one implementation of the speech-controlled interaction with a host device via a mobile phone are described. However, various implementations of the present subject matter provide numerous features including, complementing, supplementing, and/or replacing the features described above. In addition, the foregoing description, for purposes of explanation, used specific nomenclature to provide a thorough understanding of the embodiments of the invention. However, it will be apparent to one skilled in the art that the specific details are not required in order to practice the embodiments of the invention.

It is to be understood that even though numerous characteristics and advantages of various embodiments of the present invention have been set forth in the foregoing description, together with details of the structure and function of various embodiments of the invention, this disclosure is illustrative only. In some cases, certain subassemblies are only described in detail with one such embodiment. Nevertheless, it is recognized and intended that such subassemblies may be used in other embodiments of the invention. Practitioners skilled in the art will recognize many modifications and variations. Changes may be made in detail, especially matters of structure and management of parts within the principles of the embodiments of the present invention to the full extent indicated by the broad general meaning of the terms in which the appended claims are expressed.

Having disclosed exemplary embodiments and the best mode, modifications and variations may be made to the disclosed embodiments while remaining within the scope of the embodiments of the invention as defined by the following claims.

1. A computer-implemented method for implementing an AR inquiry mode, comprising:
receiving, by a camera of a device, an image;
recognizing one or more virtual objects in the image;
determining, based on a relevance score, a respective probability that a user will interact with the one or more virtual objects;
determining a relevant object based on the respective probability exceeding a predetermined threshold from the one or more virtual objects in the image;
overlying, in the image, text indicating a corresponding key phrase associated with the relevant object on a display of the device;
receiving speech audio from the user;
inferring a key phrase associated with the relevant object based on the speech audio; and
enabling an interaction session with the user, wherein the user can obtain information related to the relevant obj ect via a voice interface of the device.

2. The computer-implemented method of claim 1, further comprising:
prior to receiving an image, receiving an explicit user input to activate the AR inquiry mode; and
activating the AR inquiry mode.

3. The computer-implemented method of claim 2, further comprising:
initializing the AR inquiry mode by capturing the visual surroundings of the device with a camera of the device.

4. The computer-implemented method of claim 1, further comprising:
prior to receiving an image, inferring, based on user input data, an implied user intention to activate the AR inquiry mode; and
activating the AR inquiry mode.

5. The computer-implemented method of claim 4, further comprising:
initializing the AR inquiry mode by capturing the visual surroundings of the device with a camera of the device.

6. The computer-implemented method of claim 1, further comprising:
determining location data of the one or more virtual objects in the image.

7. The computer-implemented method of claim 1, further comprising:
determining a respective type of the one or more virtual objects in the image; and
requesting data entries for the one or more virtual objects based on the respective type.

8. The computer-implemented method of claim 1, further comprising:
requesting data entries for the one or more virtual objects; and
receiving a plurality of available data entries related to the relevant object.

9. The computer-implemented method of claim 8, further comprising:
determining, based on the plurality of available data entries, one or more suggested queries; and
rendering, in the image, text indicating the one or more suggested queries on the display.

10. (canceled)

11. The computer-implemented method of claim 1, wherein the relevance score comprises one or more of the user's input, user's gesture data, location and/or position data of the relevant object and a predetermined relevancy designation.

12. The computer-implemented method of claim 1, further comprises:
receiving, from an information provider, customized information related to the relevant object; and
providing the customized information to the user in the interaction session.

13. The computer-implemented method of claim 1, wherein the corresponding key phrase is a predetermined wake-up phrase.

14. The computer-implemented method of claim 1, wherein a rendering of the text indicating the corresponding key phrase is anchored to the relevant object in the image.

15. The computer-implemented method of claim 14, wherein the image is dynamically updated by the camera, and wherein the rendering of the text indicating the corresponding key phrase is adjusted in real-time.

16. The computer-implemented method of claim 1, further comprising:
tracking and reconstructing the one or more virtual objects via image processing by the device over a period of time.

17. The computer-implemented method of claim 1, wherein enabling an interaction session with the user comprises:
receiving additional speech audio of a user;
inferring, by the speech recognition system, a query associated with the relevant object based on the additional speech audio;
determining, by the device, a response to the query, and
providing a response to the query via the voice interface of the device.

18. The computer-implemented method of claim 17, wherein enabling an interaction session with the user comprises:
determining, by the speech recognition system, the query is ambiguous;
generating one or more disambiguating questions; and
providing the one or more disambiguating questions to the user.

19. A computer-implemented method, comprising:
receiving, by a camera of a device, an image;
showing the image on a display of the device;
recognizing one or more virtual objects in the image;
determining, based on a relevance score, a respective probability that a user will interact with the one or more virtual objects;
determining a relevant object based on the respective probability exceeding a predetermined threshold from the one or more virtual objects in the image; and
overlaying, in the image, text indicating a corresponding key phrase associated with the relevant object on the display.

20. The computer-implemented method of claim 19, further comprising:
determining location data of the one or more virtual objects in the image.

21. The computer-implemented method of claim 19, further comprising:
determining a respective type of the one or more virtual objects in the image; and
requesting data entries for the one or more virtual objects based on the respective type.

22. The computer-implemented method of claim 19, further comprising:
requesting data entries for the one or more virtual objects; and
receiving a plurality of available data entries related to the relevant object.

23. (canceled)

24. The computer-implemented method of claim 19, wherein the device comprises one of a smartphone, a smart car, smart glasses, and an AR headset.

25. The computer-implemented method of claim 19, wherein the device is a smart car, and wherein the display is at least one of a head-up display of the smart car or a dashboard display.

26. A computer system, comprising:
at least one processor;
a display;
at least one camera; and
memory including instructions that, when executed by the at least one processor, cause the computer system to:
receive, by the at least one camera, an image;
recognize one or more virtual objects in the image;
determining, based on a relevance score, a respective probability that a user will interact with the one or more virtual objects;
determine at least one relevant object based on the respective probability exceeding a predetermined threshold from the one or more virtual objects in the image;
overlay, in the image, text indicating a corresponding key phrase associated with the at least one relevant object on the display;
receive speech audio from the user;
infer a key phrase associated with a relevant object based on the speech audio; and
enable an interaction session with the user, wherein the user can obtain information related to the relevant object.

27. The computer system of claim 26, further comprising instructions that, when executed by the at least one processor, cause the computer system to:
determine location data of the one or more virtual objects in the image.

28. The computer system of claim 26, further comprising instructions that, when executed by the at least one processor, cause the computer system to:
request data entries for the one or more virtual objects; and
receive a plurality of available data entries related to the at least one relevant object.

29. (canceled)

30. The computer system of claim 26, wherein the relevance score comprises one or more of the user's input, user's gesture data, location and/or position data of the relevant object and a predetermined relevancy designation.

31. The computer system of claim 26, further comprising instructions that, when executed by the at least one processor, cause the computer system to:
receive, from an information provider, customized information related to the at least one relevant object; and
provide the customized information to the user in the interaction session.
